(19) United States
(12) Patent Application Publication
(10) Pub. No.: US 2008/0093995 A1
(43) Pub. Date: Apr. 24, 2008

(54) Ballast For High Intensity Discharge Lamps

(76) Inventor: Young Jin Song, Seoul (KR)

Correspondence Address: RABIN & Berdo, PC, 1101 14TH STREET, NW, SUITE 500, WASHINGTON, DC, 20005, US

(21) Appl. No.: 11/813,064

(22) PCT Filed: Oct. 18, 2005
(86) PCT No.: PCT/KR05/03459

§ 371 Date: Jun. 28, 2007

(30) Foreign Application Priority Data
Dec. 28, 2004 (KR) 10-2004-0114234

(51) Int. Cl. H05B 41/24

(52) U.S. Cl. 315/209 M

(57) ABSTRACT

A multi-lamp electronic ballast for a high intensity discharge lamp is provided. The multi-lamp electronic ballast includes a first igniter connected to the inverter unit to induce a high voltage from a current input from the inverter unit and to apply the high voltage to the first lamp and a second igniter having the one side end connected to the inverter unit and the other side end connected in parallel to a second lamp.

### TECHNICAL FIELD

The present invention relates to an electronic ballast for a high intensity discharge lamp, and more particularly, to a multi-lamp electronic ballast capable of simultaneously igniting two lamps or more.

### BACKGROUND ART

A high intensity discharge HID lamp denotes a discharge lamp having a discharge tube such as a metal lamp, a sodium lamp, and a mercury lamp and has an ignition voltage of several kilo volts due to characteristics of the discharge lamp.

In general, unlike a conventional halogen filament lamp, in the HID lamp, xenon gas and a metal compound are accurately injected in a light emitting tube thereof, and a high voltage of 20,000V or more supplied from an electronic ballast is applied to tungsten electrodes thereof, so that light emits due to collision of electrons from the tungsten to the xenon gas and the metal compound in the light emitting tube.

In comparison to the conventional halogen filament lamp, the HID lamp has an advantages in terms of no need for replacement caused by damage of such a filament of the halogen lamp, lower power consumption by about 50% than that of the halogen lamp, higher brightness at least two times than the halogen lamp, and longer life time five times than the halogen lamp. Due to these advantages, the HID lamp has been used for a light source for a next generation vehicle lamp.

The HID lamp ignition system includes a bulb, an igniter unit, and an electronic ballast. The bulb emits light by plasma discharge of xenon gas, mercury, and metal halide salts at both molybdenum electrodes in a light emitting tube. The igniter unit is an electromagnetic transformer for receiving a current from an electronic ballast and performing voltage stepping-up for igniting an arc light source in any environment and has a function of initiating the plasma discharge in the source by transmitting a high voltage pulse to the electrodes. The electronic ballast is an electronic control unit for supplying a stable power to the lamp and the igniter unit during the arc initiation state and the arc normal state.

Now, a conventional multi-lamp electronic ballast used for the HID lamp will be described with reference to FIGS. 1 and 2.

FIG. 1 is a block diagram of the conventional multi-lamp electronic ballast. Referring to FIG. 1, the conventional multi-lamp electronic ballast includes a power supply unit 100, a power control unit 110, an inverter unit 120, and an igniter unit 130. On the other hand, in a case where a power is supplied to two lamps, as shown in the figure, two powers divided from the power supply unit 100 are supplied to the two lamps, respectively. Therefore, as a portion for supplying a power to a first lamp 132a, a first power control unit 110a, a first inverter unit 120a, and a first igniter unit 130a are used, and as a portion for supplying a power to a second lamp 132b, a second power control unit 110b, a second inverter unit 120b, and a second igniter unit 130b are used.

In general, power converting schemes is classified into a direct covering scheme for directly converting AC power to AC power and an indirect converting scheme for firstly converting AC power to DC power with a rectifier and then converting the DC power to AC power with an inverter unit. The electronic ballast provided to the lamp in FIG. 1 utilizes the indirect converting scheme.

Referring to FIG. 1, since the power supply circuits for the first and second lamp 132a and 132b have the same construction, only the construction of the power supply for the first lamp 132a will be described.

The power supply unit 100 includes a power rectifier unit 101 for rectifying AC power into DC power and a power factor correction unit 102 for correcting a power factor of the rectified signal. Here, the power factor correction unit 102 may be constructed with an active power factor correction (APFC) circuit. Namely, the AC power input to the power supply unit 100 is rectified into the DC power and subjected to a power factor correction process in the power factor correction unit 102.

An output signal of the power factor correction unit 102 is applied to the first power control unit 110a and the second power control unit 110b. The first power control unit 110a has a function of stepping down a voltage stepped up in the power factor correction unit 102 to a voltage suitable to be applied to the lamp.

The first power control unit 110a can be implemented in various types. In FIG. 1, the first power control unit 110a is implemented in a feedback control type which is constructed with a first converter 111a, a voltage feedback unit 112a, and a current feedback unit 113a.

A signal of which voltage is adjusted by the first power control unit 110a is applied to a first inverter 121a, and the first inverter 121a of the first inverter unit 120a has a function of converting a DC voltage into an AC voltage.

A signal which is AC-voltage-converted by the first inverter unit 120a is applied to a first igniter 131a of the first igniter unit 130a. The first igniter 131a ignites a first lamp 132a by a high induced voltage.

FIG. 2 shows an example of an actual circuit of the conventional multi-lamp electronic ballast of FIG. 1. Referring to FIG. 2, a DC power supplied by the power supply unit 100 is input to the first power control unit and the second power control unit, as described above. The power control unit 110 shown in FIG. 1 includes a controller, a switch Q7 (Q12), a diode D5 (D7), an inductor L5 (L7), a transformer T4 (T6), two resisters R6 and R7 (R8 and R9), and a condenser (capacitor) C12 (C16) for each of the two lamps. By such a construction, the power control unit has a function as a general down converter. Here, the switch may be a semiconductor switch. All the switches described later may be replaced with any types of semiconductor devices of which current can be switched on and off by a control signal. It is obvious that, for example, a metal oxide silicon oxide field effect transistor (MOSFET), a junction field effect transistor (JFET), an insulated gate bi-polar transistor (IGBT), an intelligent power module (IPM), a thyristor, and a gate turnoff switch (GTO) may be used as the semiconductor device.

On the other hand, the inverter unit 120 includes an inverter controller, four switches Q8 to Q11 (Q13 or Q16), and two condensers C13 and C14 (C17 and C18) for each of the two lamps. In the inverter unit 120, the inverter controller turns on and off the four switches in a predetermined period to an AC voltage and output the AC voltage to each of the lamps.

The igniter 131 includes a transformer T3 (T5), a sidac D6 (D8), and a condenser C15 (C19) for each of the lamps. In the igniter, a high voltage is induced from a primary coil to a secondary coil of the transformer T3 (T5) according to the AC voltage of the inverter unit 120 to ignite each of the first and second lamps 132a and 132b.

As shown in FIGS. 1 and 2, according to such a construction of the conventional multi-lamp electronic ballast, as the number of lamps increases, the number of the power control units, the inverter units, and the igniter units also increases. Namely, since the igniter units must be connected in parallel, a large number of components are needed.

In addition, since a discharge tube of the aforementioned HID lamp has a characteristic of a negative resistance, it is difficult to develop a general electronic ballast suitable to the HID lamp. In addition, in a conventional technique of sustaining ignition by using a high frequency, since life time of the lamp is shorted due to occurrence of an acoustic resonance, a distance between the electronic ballast and the lamp is reduced in order to prevent the acoustic resonance. Since the acoustic resonance occurs in a wide ignition frequency range of from several KHz to several MHz, it is further difficult to develop the associated technique.

In addition, since an ignition voltage of several KV in the HID lamp interferes with a stable ignition, there is a need for a high performance igniter for the electronic ballast

On the other hand, any technique for simultaneously ignite two lamps with a single electronic ballast has been not proposed.

Therefore, a technique for simultaneously and stably igniting multiple HID lamps with a single electronic ballast without the acoustic resonance is required.

### SUMMARY OF THE INVENTION

The present invention provides a multi-lamp electronic ballast for a high intensity discharge lamp capable of igniting a plurality of lamps with a single electronic ballast by a construction that a plurality of the lamps share the electronic ballast.

The present invention also provides a multi-lamp electronic ballast for a high intensity discharge lamp capable of igniting a plurality of lamps with a single electronic ballast by a construction that a plurality of the lamps are directly connected to the electronic ballast.

The present invention also provides a multi-lamp electronic ballast for a high intensity discharge lamp capable of igniting one lamp or two lamps by a construction that a power control unit of the multi-lamp electronic ballast is constructed in a current controlled type.

According to an aspect of the present invention, there is provided a multi-lamp electronic ballast for a high intensity discharge lamp, the multi-lamp electronic ballast having an igniter unit connected to an inverter unit to ignite at least one lamp, wherein the igniter unit comprises: a first igniter connected to the inverter unit to induce a high voltage from a current input from the inverter unit and to apply the high voltage to the first lamp; and a second igniter having the one side end connected to the inverter unit and the other side end connected in parallel to a second lamp.

In the above aspect of the invention, the second lamp may be connected in series to the first lamp.

In addition, the second igniter may comprise a condenser. In addition, it can be easily understood by the ordinarily skilled in the art that other circuits for functioning as the condenser may be employed.

In addition, the first igniter may comprise: a transformer having a primary coil for receiving the current input from the inverter unit and a secondary coil for inducing the high voltage; and a condenser having the one side end connected to the primary coil of the transformer and the other side end connected to the inverter unit.

In addition, the first igniter may further comprise an inductor connected between the primary coil of the transformer and the condenser to pass a current received from the primary coil of the transformer.

In addition, the first igniter may further comprise a semiconductor device connected between the primary coil of the transformer and the condenser to instantaneously turn on in case of predetermined voltage or more. In addition, the semiconductor device may be a Sidac device.

In addition, in the electronic ballast, one lamp or more may be connected in series to the second lamp.

In addition, the electronic ballast may further comprise: a power supply unit for converting an AC power to a DC power and supplying the DC power; a power control unit for stepping down a voltage stepped up in the power supply unit into a voltage suitable to be supplied to the lamp; and an inverter unit for converting a DC voltage received from the power control unit to an AC voltage and supplying the converted AC voltage to the transformer in the igniter unit.

In addition, the power supply unit may comprise: a power rectifier unit for rectifying the AC power into the DC power; and a power factor correction unit for correcting a power factor of the rectified signal.

In addition, the power control unit may be constructed in a feedback control type. In addition, the power control unit may be constructed in a current controlled type.

In addition, in a case where the second lamp is removed, the electronic ballast may be capable of igniting the first lamp by connecting the one side end of the first lamp to the secondary coil of the transformer and the other side end of the first lamp to the inverter unit.

In addition, in a case where a forward voltage is applied from the primary coil of the transformer to the inductor by the inverter unit, a current flows through the primary coil of the transformer, a high voltage may be induced to the secondary coil of the transformer due to the current, and the high voltage is applied to the first lamp.

In addition, after the high voltage is applied, if a voltage across the first lamp rapidly decreases by turning on the first lamp, most of the voltage induced to the secondary coil of the transformer may be applied through the second igniter to the second lamp.

In addition, after a voltage is applied to the second lamp, if the voltage across the second lamp rapidly decreases by turning on the second lamp, no current may flow through the inductor and condenser of the first igniter, and all the voltage generated by the inverter unit may be applied to the first lamp and the second lamp.

In addition, in a case where a voltage is applied from the inductor to the primary coil of the transformer by the inverter unit, a current supplied from the inverter unit may be applied to the second igniter connected in parallel to the second lamp.

In addition, after the current is applied to the second igniter, a voltage which turns on the condenser of the first igniter may be applied through the primary coil of the transformer, and a high voltage may be induced to the secondary coil of the transformer.

In addition, the voltage induced to the secondary coil of the transformer may be applied to the first lamp and the second igniter, and a high voltage is applied to the first lamp according to charging of the second igniter. In addition, in a case where the first lamp changes into a weak conduction state, a voltage across the first lamp greatly may decrease, and the second igniter may be gradually charged, so that most of voltage inducted to the secondary coil of the transformer is applied in parallel to the second lamp through the second igniter.

In addition, if the voltage charged to the second igniter becomes a voltage capable of igniting the second lamp, a voltage across the second lamp may rapidly decreases by turning on the second lamp, so that both of the first and second lamps are in a conduction state.

According to the present invention, there is proposed an electronic ballast for supplying a stable voltage to a high intensity discharge (HID) lamp having a high ignition voltage of several kV. In particular, there is proposed a multi-lamp electronic ballast capable of igniting two lamps or more with a single electronic ballast.

In the present invention, two lamps or more directly connected are connected to a first igniter, and a second igniter is connected in parallel to a second lamp connected to the first lamp to which the igniter unit directly supplies a power.

In addition, in the first igniter, a condenser is connected to a primary coil of a transformer for supplying a high induced voltage to the lamp. Preferably, an inductor or a sidac (or a diac) may be further provided between the primary coil and the condenser. In addition, preferably, a sidac may be further provided between the inductor and the condenser. In addition, the function of the inductor may be performed by suitably adjusting the primary coil of the transformer.

In addition, a power controller of the electronic ballast according to the present invention may be constructed in a current controlled type, so that it is possible to selectively igniting one lamp or two lamps without any circuit modification thereof.

As described above, in a conventional multi-lamp electronic ballast, since the first power control unit, the second power control unit, the first inverter unit, the second inverter unit, the first igniter unit, and the second igniter unit are constructed in parallel, a large number of components are needed. However, according to the present invention, it is possible to reduce the number of components of the electronic ballast by half or less. Therefore, it is possible to reduce production cost, size, and weight of the electronic ballast. In addition, it is possible to improve an efficiency of the electronic ballast. In addition, it is possible to further reduce an installation space, weight, and components of the electronic ballast in comparison to a conventional technique where two electronic ballasts are used.

In addition, since the efficiency of the electronic ballast can be improved, it is possible to reduce consumption of resources and energy. In addition, in the multi-lamp electronic ballast according to the present invention, since the controller of the power control unit can be constructed in a current controlled type, a single lamp or two lamps are selectively ignited, so that it is possible to further improve the efficiency thereof in the industry. In addition, the current controlled type controller may be implemented in a pulse width modulation (PWM) type or a pulse frequency modulation (PFM) type in order to turn on and off a switch Q5 by using a feed back current flowing through the transformer T2.

### BRIEF DESCRIPTION OF THE DRAWING

The above and other features and advantages of the present invention will become more apparent by describing in detail exemplary embodiments thereof with reference to the attached drawings in which:

FIG. 1 is a block diagram showing a conventional multi-lamp electronic ballast;

FIG. 2 is a detailed circuit diagram of the conventional multi-lamp electronic ballast;

FIG. 3 is a block diagram showing a multi-lamp electronic ballast according to an embodiment of the present invention;

FIG. 4 is a detailed circuit diagram of the multi-lamp electronic ballast according to the embodiment of the present invention;

FIG. 5 is a circuit diagram of a power supply unit of the multi-lamp electronic ballast according to the embodiment of the present invention;

FIG. 6 is a circuit diagram of a power control unit of the multi-lamp electronic ballast according to the embodiment of the present invention;

FIGS. 7 and 8 are circuit diagrams of an inverter unit used for a multi-lamp electronic ballast according to an embodiment of the present invention;

FIG. 9 is a circuit diagram of an igniter unit of a multi-lamp electronic ballast according to a first embodiment of the present invention;

FIG. 10 is a circuit diagram of an igniter unit of a multi-lamp electronic ballast according to a second embodiment of the present invention; and

FIG. 11 is a circuit diagram showing a construction where only the first lamp is connected to the igniter unit of the multi-lamp electronic ballast according to the second embodiment of the present invention.

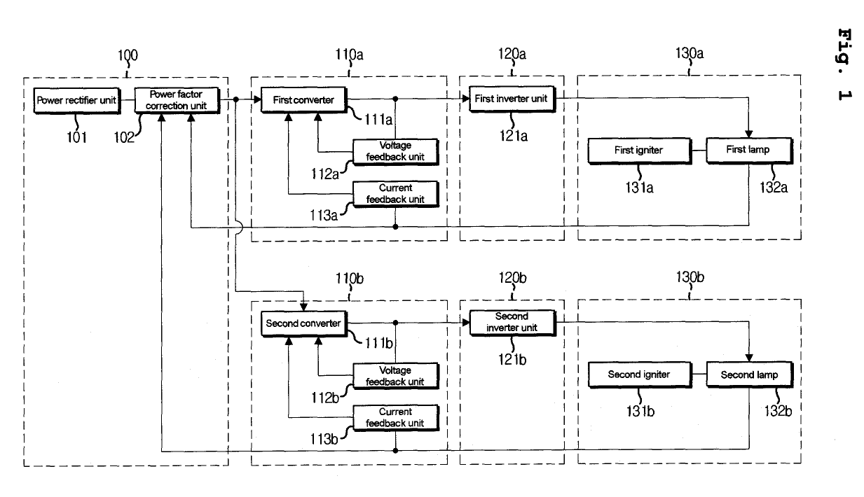

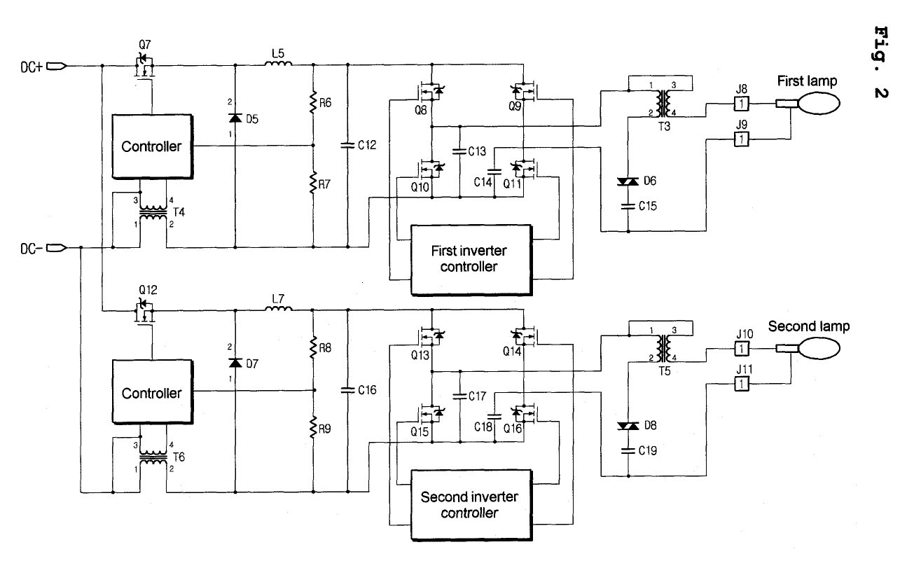

### BEST MODE FOR CARRYING OUT THE INVENTION

Now, preferred embodiments of the present invention will be described in detail with reference to the accompanying drawings. In the description, well-known constructions or components which may not clarify the construction of the present invention will be omitted.

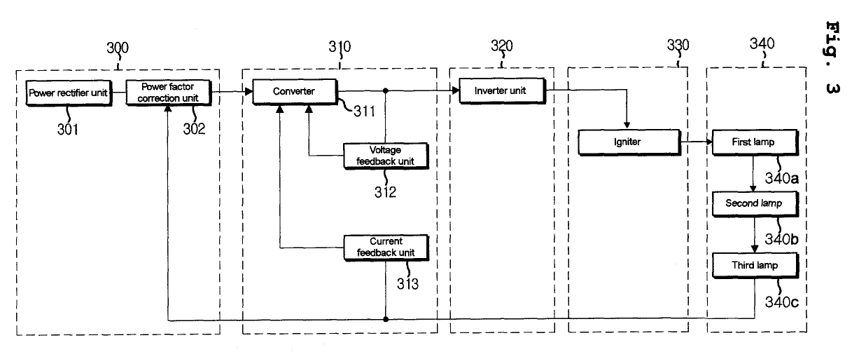

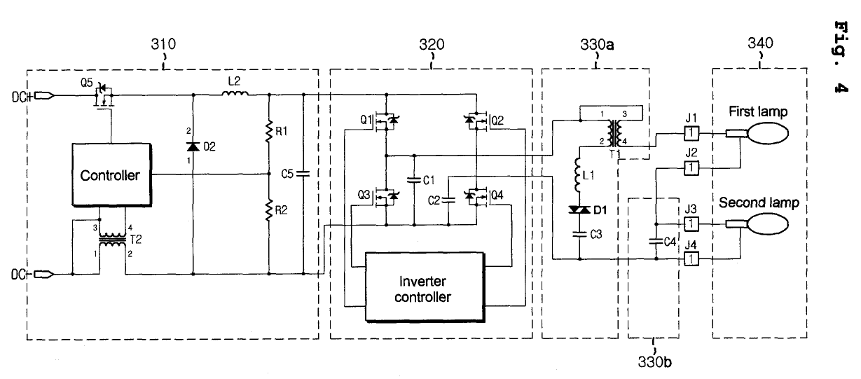

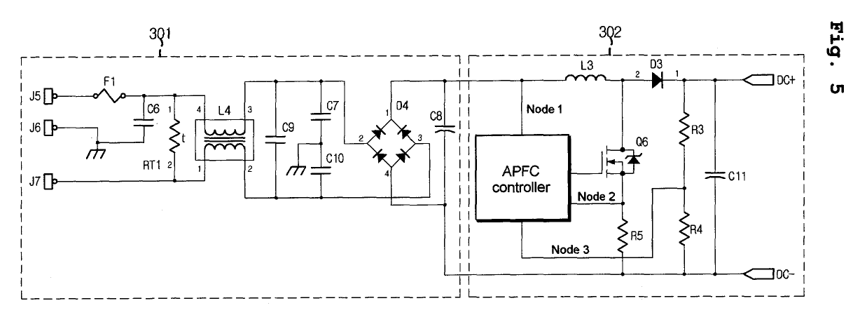

A whole construction and circuit of a multi-lamp electronic ballast according to an embodiment of the present invention will be described with reference to FIGS. 3 and 4, and detailed construction of components of the multi-lamp electronic ballast will be described with reference to FIGS. 5 to 11.

FIG. 3 is a block diagram showing the multi-lamp electronic ballast according to the embodiment of the present invention.

Referring to FIG. 3, the multi-lamp electronic ballast according to the embodiment of the present invention includes a power supply unit 300, a power control unit 310, an inverter unit 320, and an igniter unit 330.

Conventionally, the power control units 310, the inverter units 320, and the igniter units 330 corresponding to the number of lamps are needed. However, according to the present invention, the lamps 340 are connected in series to each other, and power is supplied through a single igniter, so that an electronic ballast having a simple construction can be implemented even in a case where the number of lamps increases. The electronic ballast shown in FIG. 3 is an indirect converting type electronic ballast using an inverting unit in conversion for AC power.

The power supply unit 300 may be constructed with a power rectifier unit 301 for rectifying AC power into DC power and a power factor correction unit 302 for correcting power factor of the rectified signal. Here, the power factor correction unit 302 may be constructed with an active power factor correction (APFC) circuit. Namely, the AC power input to the power supply unit 300 is rectified into the DC power by the power rectifier unit 301 and subjected to a power factor correction process in the power factor correction unit 302.

An output signal of the power factor correction unit 302 is applied to the power control unit 310. The power control unit 310 has a function of stepping down a voltage stepped up in the power factor correction unit 302 to a voltage suitable to be applied to the lamp.

The power control unit 310 can be implemented in various types. For example, there are a voltage controlled type, a current controlled type, and a power controlled type in which the voltage and current are controlled. In addition, a feedback control type may be used in order to obtain more accurate result.

Referring to FIG. 3, the power control unit 310 is of a feedback control type and constructed with a converter 311, a voltage feedback unit 312, and a current feedback unit 313.

A signal of which voltage is adjusted in the power control unit 310 is applied to an inverter in the inverter unit 320, and the inverter converts a DC voltage to an AC voltage.

The signal of which voltage is converted in to the AC voltage by the inverter unit 320 is applied to an igniter of the igniter unit 330. According to the present invention, the igniter uses a high induced voltage to ignite the first and second lamps 340a and 340b.

Namely, according to the present invention, the igniter supplies a power to both of the first lamp 340a and the second lamp 340b directly connected to the first lamp 340a, so that a multi-lamp electronic ballast can be implemented with much simpler construction than a conventional electronic ballast.

FIG. 4 is a detailed circuit diagram of the multi-lamp electronic ballast according to the embodiment of the present invention.

Referring to FIG. 4, a DC power supplied by the power supply unit 300 is input to the power control unit 310, as described above. The power control unit 310 described with reference to FIG. 3 is constructed with a controller, a switch Q5, a diode D2, an inductor L2, a transformer T2, two resisters R1 and R2, and a condenser (capacitor) C5. By the construction, the power control unit 310 performs an operation such as that of a general down converter. The detail construction and operations of the power control unit 310 will be described later with reference to FIG. 6.

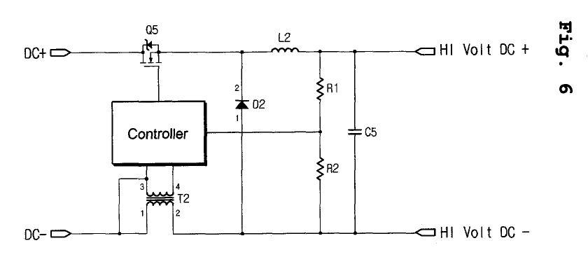

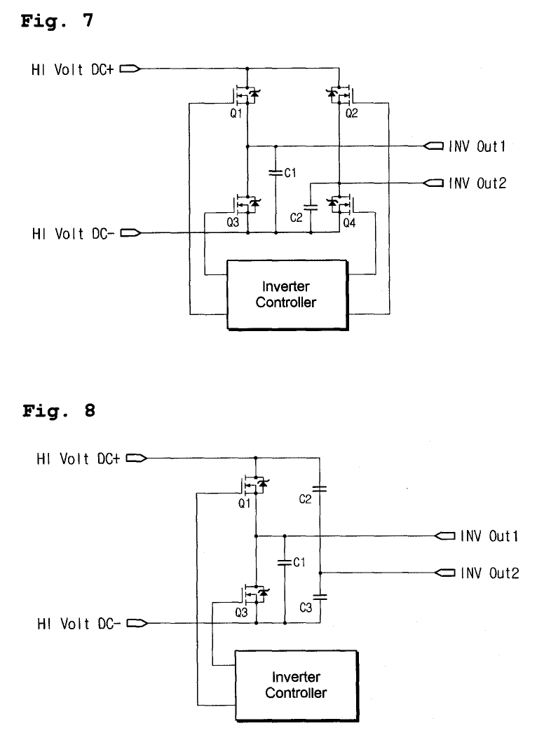

On the other hand, the inverter unit 320 may be constructed with an inverter controller and four switches Q1 to Q4, and two condensers C1 and C2. The inverter unit 320 generates an AC voltage according to the switch on and off of the four switches Q1 to Q4 in a predetermined period by the inverter controller and outputs the generated AC voltage to an igniter. The detailed construction and operations of the inverter unit 320 will be described later with reference to FIGS. 7 and 8.

The igniter may be constructed with a first igniter 330a and a second igniter 330b. The first igniter 330a includes a transformer T1 and a condenser C3. In addition, the first igniter 330a may further selectively or simultaneously includes an inductor L1 and a sidac D1 between the primary coil of the transformer T1 and the condenser C. The second igniter includes a condenser C4. In the igniters 330a and 330b, a high voltage is induced from the primary coil to the secondary coil of the transformer T1 according to the AC voltage of the inverter unit 320, so that the first and second lamps are ignited. The detailed construction and operations of the igniters will be described later with reference to FIGS. 8 to 10.

Now, constructions and operations of components of the electronic ballast according to the embodiment of the present invention described with reference to FIGS. 3 and 4 will be described in detail with reference to FIGS. 5 to 10.

FIG. 5 is a circuit diagram of a power supply unit of the multi-lamp electronic ballast according to the embodiment of the present invention.

Referring to FIG. 5, the power supply unit 300 of the electronic ballast according to the embodiment may include a power rectifier unit 301 and a power factor correction unit 302, as described above.

The power rectifier unit 301 may include a fuse F1, a resister R1, a transformer L4, condensers (capacitor) C6 to C10, and a diode D4. In addition, the power factor correction unit 302 may includes an APFC controller, a switch Q6, an inductor L3, resisters R3, R4, and R5, and a condenser C11.

The power rectifier unit 301 of the power supply unit 300 is constructed with a rectifier for converting an input AC power to a DC power and a boost converter for stepping up the converted DC power up to a suitable voltage. During the stepping-up operation, an operation for correcting a power factor is performed. A bridge diode D4 is used as the rectifier of the power rectifier unit 301.

The power factor correction unit 302 basically operates similar to the boost converter and monitors the voltage rectified by the bridge diode D4 at a node 1 so as to correct the power factor to be approximately 1.

More specifically, if the APFC controller turns on the switch Q6, a large amount of the current flows through the inductor L3. At this time, a predetermined voltage or more is sensed at a node 2, the APFC controller turns off the switch Q6. On the other hand, due to the characteristics of the coil for sustaining the current flowing through the inductor L3, the current flows. Therefore, since the switch Q6 is turned off, the current is charged to the condenser C11 through the diode D3.

At this time, the charged voltage is fed back to a node 3 by resistance division of the resisters R3 and R4, and if the feed-back voltage exceeds a reference voltage, the APFC controller stops the aforementioned operation. On the contrary, if the feed-back voltage does not exceed the reference voltage, the APFC controller maintains the aforementioned charging operation.

FIG. 6 is a circuit diagram of a power control unit of the multi-lamp electronic ballast according to the embodiment of the present invention.

Referring to FIG. 6, the power control unit 310 has a construction of a DC-DC converter for stepping down the voltage stepped up in the power factor correction unit 302 of the power supply unit 300 to a suitable voltage.

The operation types of the power control unit 310 are mainly divided into three types of a voltage controlled type, a current controlled type, and a power controlled type in which the voltage and current are controlled. By using these types of the power control unit 310, a good result can be obtained.

In order to obtain more accurate result, a feedback control type of the power control unit 310 is used in the present invention.

The power control unit 310 may be constructed with a controller, a switch Q5, a transformer T2, an inductor L2, resisters R1 and R2, a diode D2, and a condenser C5.

In FIG. 6, the power control unit 310 is constructed with a non-insulating type down converter which operates similar to a general down converter. More specifically, the voltages divided by the resisters R1 and R2 are fed back to the controller, and the current is fed back by using the transformer T2. Here, although the transformer T2 may be replaced with a power resister, the same effect can be obtained. In addition, a free wheeling diode may be used as the diode D2.

On the other hand, the power control unit 310 has another operation for applying the voltage stepped up in the power factor correction unit 302 during the igniting operation to the load, that is, a lamp and an igniter, so that a stable ignition can be implemented. The igniting operations will be described later when the igniter unit is described.

FIGS. 7 and 8 are circuit diagrams of an inverter unit used for a multi-lamp electronic ballast according to an embodiment of the present invention. The inverter unit 320 may be constructed in a full bridge (or H bridge) type or a half bridge type. Namely, FIG. 7 shows a full bridge type inverter unit, and FIG. 8 shows a half bridge type inverter unit.

The inverter unit 320 has a function of converting a DC voltage to an AC voltage. The inverter unit used in FIG. 4 is the full bridge type inverter unit, but a general half bridge type inverter unit may be used without any problem in ignition and driving of the lamp.

On the other hand, a frequency of the power supplied to the lamp is determined based on the operation of the inverter unit 320. In order to prevent occurrence of acoustic resonance, the inverter unit operates in an operational frequency range of several Hz to several kHz.

According to a result of experiment, since the acoustic resonance phenomena occur sporadically at a frequency of 1 kHz or more, it is preferable that the inverter unit operates in a frequency range of several hundred Hz. If the operational frequency of the inverter unit is high, the power applied to the lamp decreases, and if the operational frequency of the inverter unit is low, the power applied to the lamp increases. On the other hand, it is preferable that the operational frequency of the inverter unit 320 is fixed to be independent of other components.

Referring to FIG. 7, the full bridge type inverter unit includes an inverter controller, four switches Q1, Q2, Q3, and Q4, and two condensers C1 and C2. The inverter controller has a function of turning on and off the switches Q in a predetermined period.

In the full bridge type inverter unit of FIG. 7, the switches Q1 and Q4 are simultaneously turned on, and when the switches Q1 and Q4 are turned on, the switches Q2 and Q3 are turned off. In the next period, the switches Q1 and Q4 are turned off, and the switches Q2 and Q3 are turned on. The turning on and off of the switches is repeatedly performed in a predetermined period.

Referring to FIG. 8, the half bridge type inverter unit includes an inverter controller, two switches Q1 and Q3, and three condensers C1, C2, and C3. As described above, the inverter controller has a function of turning on and off the switches Q in a predetermined period.

In the half bridge type inverter unit of FIG. 8, when the switch Q1 is turned on, the switch Q3 is turned off, and when the switch Q3 is turned on, the switch Q1 is turned off. The turning on and off of the switches is repeated performed in a predetermined period.

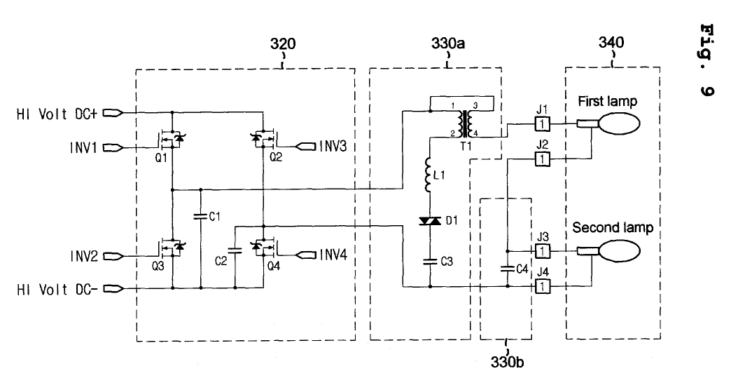

FIG. 9 is a circuit diagram of an igniter unit of a multi-lamp electronic ballast according to the first embodiment of the present invention.

Referring to FIG. 9, the igniter unit 330 according to a first embodiment of the present invention is directly connected to two lamps. Conventionally, if the two lamps are directly connected to the igniter unit, an ignition voltage increases two times, so that there is a difficulty in ignition. However, the voltage can be applied to multiple lamps by using the igniter unit having the construction according to the present invention. On the other hand, although two lamps are connected to a single igniter in the later-described embodiment, three or more lamps may be directly connected, so that multiple lamps can be ignited by using a single electronic ballast.

The igniter unit 330 according to the first embodiment of the present invention includes a first igniter 330a and a second igniter 330b. The first igniter 330a includes a transformer T1 connected to the first lamp and a condenser C3. The first igniter 330a may further comprise an inductor L1 and a sidac D1 selectively or simultaneously. The second igniter 2 includes a condenser C4 connected in parallel to the second lamp.

Namely, in the igniter unit 330 according to the first embodiment of the present invention, two or more lamps are directly connected to the igniter, and the condenser C4 is connected in parallel to the second lamp directly connected to the first lamp which the igniter directly supplies power to.

Conventionally, a sidac (or diac) D1 and a condenser C3 are connected to a primary coil of the transformer T1 of the igniter unit for supplying a high induced voltage to the lamp. However, according to the present invention, an inductor L1 is added between the primary coil of the transformer T1 and the sidac D1, so that a voltage can be efficiently applied to the two lamps.

Now, operations of the igniter will be described in detail. The igniter ignites the two lamps according to the following turning on/off operation of the inverter unit

(1) Q1 and Q4 of Inverter Unit 320: On

A current is applied to a pin 1 of the transformer T1, and the current flows through the primary coil of the transformer T1. The current from the primary coil of the transformer T1 flows through the inductor L1 to the sidac D1, so that a voltage is applied to the sidac D1. The sidac D1 is a bi-directional thyristor diode device which is instantaneously turned on at a voltage exceeding a predetermined voltage, so that a resistance thereof becomes approximately zero.

Other bi-directional diode devices such as a diac and triac may be used instead of the sidac D1.

On the other hand, if a voltage applied by the inverter unit 320 exceeds a pass voltage of the sidac D1, a current instantaneously flows through the sidac D1, and the condenser C3 is charged with the current. At this time, a high voltage of several kV is induced to the secondary coil of the transformer T1, and the high voltage is applied to the first lamp and the second igniter. Next, due to the flow of the current which charges the second igniter, the first lamp is changed to a weak conduction state.

Like this, if the first lamp is changed to the weak conduction state, the resistance of the lamp becomes approximately zero due to the characteristics of the HID lamp, and the voltage across the first lamp rapidly decreases. At this time, most of the voltage induced to the secondary coil of the transformer T1 is applied to the condenser C4, that is, a second igniter, and the voltage is applied in parallel to the second lamp.

By doing so, if the voltage charged to the second igniter approaches to a voltage capable of igniting the second lamp, the second lamp is changed to a conduction state, and the voltage applied to the second lamp rapidly decreases. At this time, both of the first and second lamps are in a conduction state, and the resistances of the first and second lamps become approximately zero. Therefore, the voltage across the output terminal of the inverter unit 320 rapidly decreases, the voltage applied through the primary coil of T1, the inductor L1, and the sidac D1 to the condenser C3 also rapidly decreases. Due to the decrease in the voltage, the sidac D1 is changed to an off state, so that any current does not flow.

After that, all the voltage generated by the inverter unit 320 flows the lamps, that is, the first and second lamps, and as a temperature of the lamps gradually increases due to the characteristics of the HID lamp, internal resistances of the lamps increase. As a result, the voltage increases up to a predetermined voltage, and then, is maintained in the predetermined voltage.

(2) Q2 and Q3 of Inverter Unit 320: On

A current applied to the inverter unit 320 is firstly applied to the condenser C3 connected in parallel to the second lamp, and a current flows through the condenser C3 due to the characteristics of the condenser that passes a varying voltage. The voltage enabling the condenser C3 to conduct the current is applied through the sidac D1 and the inductor L1 to the primary coil of the transformer T1. When the voltage of the inverter exceeds a pass voltage of the sidac dl, the sidac D1 instantaneously conducts a current, and the current flows through the inductor L1 to the primary coil of the transformer T1.

At this time, a high voltage of several kV is induced to the secondary coil of the transformer T1, and the high voltage is applied to the first lamp and the second igniter. Next, due to the flow of the current which charges the second igniter, a high voltage is applied to the first lamp, and the first lamp is changed to a weak conduction state.

Like this, if the first lamp is changed to the weak conduction state, the resistance of the lamp becomes approximately zero due to the characteristics of the HID lamp, and the voltage across the first lamp rapidly decreases.

In addition, as the condenser C4 is gradually charged, most of the voltage induced to the secondary coil of the transformer T1 is applied to the condenser C4, that is, a secondary igniter, and the voltage is applied in parallel to the second lamp. At this time, if the voltage charged to the second igniter approaches to a voltage capable of igniting the second lamp, the second lamp is changed to a conduction state, and the voltage applied to the second lamp rapidly decreases. As a result, both of the first and second lamps are in a conduction state, the resistances of the first and second lamps become approximately zero.

Therefore, the voltage across the output terminal of the inverter unit 320 rapidly decreases, the voltage applied through the condenser C3, the sidac D1, and the inductor L1 to the primary coil of T1 also rapidly decreases. Due to the decrease in the voltage, the sidac D1 is changed to an on state, so that any current does not flow.

After that, all the voltage generated by the inverter unit 320 flows the lamps, that is, the first and second lamps, and as a temperature of the lamps gradually increases due to the characteristics of the HID lamp, internal resistances of the lamps increase. As a result, the voltage increases up to a predetermined voltage, and then, is maintained in the predetermined voltage.

In addition, according to the present invention, since the lamps are used in a directly connected state, the current flowing through the converter and the inverter does not increase. Therefore, heat decreases, and the heat can be easily released.

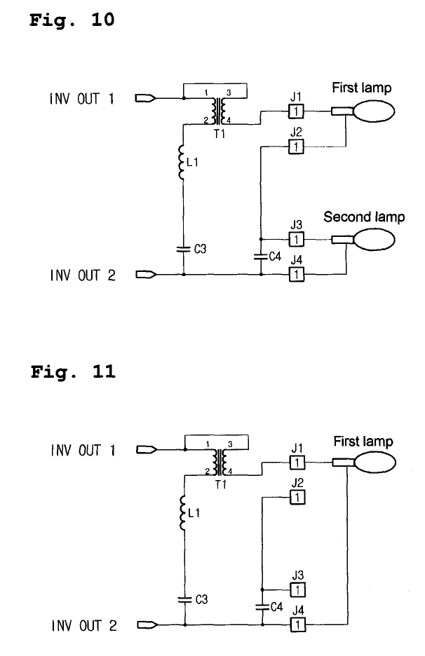

Now, an igniter unit according to a second embodiment of the present invention will be described with reference to FIG. 10. In the second embodiment, the sidac D1 of the first igniter according to the first embodiment is removed. In other words, although the sidac D1 is removed, the same effect can be obtained by using only the transformer T1, the inductor L1, and the condenser C3.

FIG. 10 is a circuit diagram of an igniter unit of a multi-lamp electronic ballast according to the second embodiment of the present invention.

Referring to FIG. 10, the igniter unit according to the second embodiment of the present invention is constructed by removing the sidac from the igniter of the first embodiment. Namely, the igniter unit 330 according to the second embodiment of the present invention includes a first igniter and a second igniter, wherein the first igniter is constructed with a transformer T1, an inductor L1, and a condenser C3 which are connected to the first lamp. In addition, the second igniter is constructed with a condenser C4 connected in parallel to the second lamp.

Like this, according to the second embodiment, although the sidac D1 of the first igniter is removed, the same effect as that of the first embodiment can be obtained. Now, operation of the igniter unit according to the second embodiment will be described.

(1) INV OUT 1: Positive Voltage and INV OUT 2: Negative Voltage

Initially, the first and second lamps are in an off state. Therefore, a voltage applied is charged through the primary coil of the transformer and the inductor L1 to the condenser C3. At this time, due to a flow of a current, a high voltage is induced to the secondary coil of the transformer T1. On the other hand, all the induced voltage is applied to the first lamp, so that the first lamp is in a conduction state. The current of conducting the first lamp charges the condenser C4 connected in parallel to the second lamp, and when a charged voltage of the second lamp becomes a voltage capable of conducting the second lamp, the second lamp is in a conduction state.

When the first and second lamps are in a conduction state, the resistances thereof instantaneously decrease, so that all the current generated in the inverter unit 320 flows through the secondary coil of the transformer T1 and the first lamp to the second lamp.

After a few time elapses, a temperature of the lamps increases, and the internal resistances of the lamps increases due to increase in temperature of the lamps. As a result, suitable voltages are provided to the lamps.

Even in this case, a current flows through the primary coil of the transformer T1 and the inductor L1 to the condenser C3, so that a voltage is induced in a direction of a current flowing through the secondary coil of the transformer T1, that is, a direction of from INV OUT 1 through the secondary coil of the transformer T1, the first lamp, and the second lamp to the INV OUT 2. The induced voltage is generated due to a periodic change of a voltage applied to the power control unit 310 and the inverter unit 320, so that a periodic pulse type voltage is applied to the lamps. It is well known to the ordinarily skilled in the art that a high frequency vibrating current applied to a lamp can improve an efficiency of a discharge tube.

Namely, according to the embodiment of the present invention, in the operation of the igniter after the ignition of the lamps, the high frequency current is applied to the lamps, so that it is possible to improve the efficiency of the lamps.

(2) INV OUT 1: Negative Voltage and INV OUT 2: Positive Voltage

Initially, the first and second lamps are in an off state. Therefore, a voltage applied from the inverter unit 320 passes through the condenser C3 due to the characteristics of the condenser C3 of passing a varying voltage and flows through the inductor L1 and the primary coil of the transformer T1 to the INV OUT 1. At this time, due to a flow of a current, a high voltage is induced to the secondary coil of the transformer T1. All the induced voltage is applied to the first lamp, so that the first lamp is in a conduction state. Like this, when the first lamp is in a conduction state, the resistance of the first lamp instantaneously becomes approximately zero, and the applied voltage is applied to the condenser C4 and the second lamp. At this time, the condenser C4 is charged, and when the charged voltage of the condenser C4 becomes a voltage capable of conducting the second lamp, the second lamp is in a conduction state.

By doing so, if the first and second lamps are in a conduction state, the resistances of the lamps instantaneously decrease due to the characteristics of the HID lamp, and all the current generated in the inverter unit flows through the second lamp and the first lamp to the secondary coil of the transformer T1. After a few time elapses, a temperature of the lamps increases, and the internal resistances of the lamps increases due to increase in temperature of the lamps. As a result, suitable voltages are provided to the lamps.

Even in this case, a current flows through the condenser C3 and the inductor L1 to the primary coil of the transformer T1, so that a voltage is induced in a direction of a current flowing through the secondary coil of the transformer T1, that is, a direction of from INV OUT 2 through the second lamp, the first lamp, the secondary coil of the transformer T1 to INV OUT 1.

On the other hand, the induced voltage is generated due to a periodic change of a voltage applied to the power control unit 310 and the inverter unit 320, so that a periodic pulse type voltage is applied to the lamps. It is well known to the ordinarily skilled in the art that a high frequency vibrating current applied to a lamp can improve an efficiency of a discharge tube.

There, although the direction of the current flow is changed, in the operation of the igniter after the ignition of the lamps, the high frequency current is applied to the lamps, so that it is possible to improve the efficiency of the lamps.

FIG. 11 is a circuit diagram showing a construction where only the first lamp is connected to the igniter unit of the multi-lamp electronic ballast according to the second embodiment of the present invention.

Referring to FIG. 11, if the power control unit 310 is constructed in a current controlled type, the electron ballast can operate normally for two lamps as well as for a single lamp. In other words, an electronic ballast capable of igniting a single lamp or two lamps can be implemented. In a case where the electron ballast operates in order to ignite a single lamp, an upper line J1 of the first lamp and a lower line J4 of the second lamp are connected to a single lamp.

Heretobefore, the components of the electronic ballast are described. Although the embodiment for two lamps is described, it can be understood by the ordinarily skilled in the art that the present invention can be applied for three lamps or more.

### INDUSTRIAL APPLICABILITY

According to the present invention, two lamps or more can be ignited by using a single electronic ballast, it is possible to reduce the number of components of the electronic ballast by half or less. Therefore, it is possible to reduce production cost, size, and weight of the electronic ballast. In addition, it is possible to improve an efficiency of the electronic ballast.

In addition, it is possible to further reduce an installation space, weight, and components of the electronic ballast in comparison to a conventional technique where two electronic ballasts are used.

In addition, since the efficiency of the electronic ballast can be improved, it is possible to reduce consumption of resources and energy.

In addition, in the multi-lamp electronic ballast according to the present invention, since the controller of the power control unit can be constructed in a current controlled type, a single lamp or two lamps are selectively ignited, so that it is possible to further improve the efficiency thereof in the industry.

Although the exemplary embodiments and the modified examples of the present invention have been described, the present invention is not limited to the embodiments and examples, but may be modified in various forms without departing from the scope of the appended claims, the detailed description, and the accompanying drawings of the present invention. Therefore, it is natural that such modifications belong to the scope of the present invention.

1. A multi-lamp electronic ballast for a high intensity discharge lamp, the multi-lamp electronic ballast having an igniter unit connected to an inverter unit to ignite at least one lamp, wherein the igniter unit comprises:
a first igniter connected to the inverter unit to induce a high voltage from a current input from the inverter unit and to apply the high voltage to the first lamp; and
a second igniter having the one side end connected to the inverter unit and the other side end connected in parallel to a second lamp.

2. The multi-lamp electronic ballast according to claim 1, wherein the second lamp is connected in series to the first lamp.

3. The multi-lamp electronic ballast according to claim 1, wherein the second igniter comprises a condenser.

4. The multi-lamp electronic ballast according to claim 1, wherein the first igniter comprises:
a transformer having a primary coil for receiving the current input from the inverter unit and a secondary coil for inducing the high voltage; and
a condenser having the one side end connected to the primary coil of the transformer and the other side end connected to the inverter unit.

5. The multi-lamp electronic ballast according to claim 4, wherein the first igniter further comprises an inductor connected between the primary coil of the transformer and the condenser to pass a current received from the primary coil of the transformer.

6. The multi-lamp electronic ballast according to claim 4, wherein the first igniter further comprises a semiconductor device connected between the primary coil of the transformer and the condenser to instantaneously turn on in case of predetermined voltage or more.

7. The multi-lamp electronic ballast according to claim 5, wherein the first igniter further comprises a semiconductor device connected between the primary coil of the transformer and the condenser to instantaneously turn on in case of predetermined voltage or more.

8. The multi-lamp electronic ballast according to claim 7, wherein the semiconductor device is a Sidac device.

9. The multi-lamp electronic ballast according to claim 1, wherein, in a case where a third lamp connected in series to the second lamp is added, the electronic ballast further comprises a second igniter connected in parallel to the added lamp.

10. The multi-lamp electronic ballast according to claim 1, wherein the electronic ballast further comprises:
a power supply unit for converting an AC power to a DC power and supplying the DC power;
a power control unit for stepping down a voltage stepped up in the power supply unit into a voltage suitable to be supplied to the lamp; and
an inverter unit for converting a DC voltage received from the power control unit to an AC voltage and supplying the converted AC voltage to the transformer in the igniter unit.

11. The multi-lamp electronic ballast according to claim 10, wherein the power supply unit comprises:
a power rectifier unit for rectifying the AC power into the DC power; and
a power factor correction unit for correcting a power factor of the rectified signal.

12. The multi-lamp electronic ballast according to claim 10, wherein the power control unit is constructed in a feedback control type.

13. The multi-lamp electronic ballast according to claim 10, wherein the power control unit is constructed in a current controlled type.

14. The multi-lamp electronic ballast according to claim 1, wherein, in a case where the second lamp is removed, the electronic ballast is capable of igniting the first lamp by connecting the one side end of the first lamp to the secondary coil of the transformer and the other side end of the first lamp to the inverter unit.

15. The multi-lamp electronic ballast according to claim 5, wherein, in a case where a forward voltage is applied from the primary coil of the transformer to the inductor by the inverter unit, a current flows through the primary coil of the transformer, a high voltage is induced to the secondary coil of the transformer due to the current, and the high voltage is applied to the first lamp.

16. The multi-lamp electronic ballast according to claim 15, wherein, after the high voltage is applied, if a voltage across the first lamp rapidly decreases by turning on the first lamp, most of the voltage induced to the secondary coil of the transformer is applied through the second igniter to the second lamp.

17. The multi-lamp electronic ballast according to claim 16, wherein, after a voltage is applied to the second lamp, if the voltage across the second lamp rapidly decreases by turning on the second lamp, no current flows through the inductor and condenser of the first igniter, and all the voltage generated by the inverter unit is applied to the first lamp and the second lamp.

18. The multi-lamp electronic ballast according to claim 5, wherein, in a case where a voltage is applied from the inductor to the primary coil of the transformer by the inverter unit, a current supplied from the inverter unit is applied to the second igniter connected in parallel to the second lamp.

19. The multi-lamp electronic ballast according to claim 18, wherein, after the current is applied to the second igniter, a voltage which turns on the condenser of the first igniter is applied through the primary coil of the transformer, and a high voltage is induced to the secondary coil of the transformer.

20. The multi-lamp electronic ballast according to claim 19, wherein the voltage induced to the secondary coil of the transformer is applied to the first lamp and the second igniter, and a high voltage is applied to the first lamp according to charging of the second igniter.

21. The multi-lamp electronic ballast according to claim 20, wherein, in a case where the first lamp changes into a weak conduction state, a voltage across the first lamp rapidly decrease, and the second igniter is gradually charged, so that most of voltage inducted to the secondary coil of the transformer is applied in parallel to the second lamp through the second igniter.

22. The multi-lamp electronic ballast according to claim 21, wherein, if the voltage charged to the second igniter becomes a voltage capable of igniting the second lamp, a voltage across the second lamp rapidly decreases by turning on the second lamp, so that both of the first and second lamps are in a conduction state.

23. The multi-lamp electronic ballast according to claim 6, wherein the semiconductor device is a Sidac device.
